(19) United States
(12) Patent Application Publication
(10) Pub. No.: US 2017/0349011 A1
(43) Pub. Date: Dec. 7, 2017

(54) DEVICE FOR HYDRAULICALLY DEMOUNTING TIRE OF HEAVY DUTY VEHICLE

(71) Applicant: SHANGHAI LIKANG INTERNATIONAL TRADING., LTD., Shanghai (CN)

(72) Inventor: Songqian GAO, Shanghai (CN)

(73) Assignee: SHANGHAI LIKANG INTERNATIONAL TRADING., LTD., Shanghai (CN)

(21) Appl. No.: 15/539,148

(22) PCT Filed: Jan. 28, 2015
(86) PCT No.: PCT/CN2015/071699

§ 371 Date: Jun. 23, 2017

(30) Foreign Application Priority Data
Dec. 31, 2014 (CN) 201410849541.1

(51) Int. Cl. B60C 25/128

(52) U.S. Cl. CPC B60C 25/128

(57) ABSTRACT

The present invention provides a device for hydraulically demounting a tire of a heavy duty vehicle consisting of a tire (6) and a rim (8), wherein, a plurality of oil cylinder installation holes (5) are evenly distributed on the periphery of an end face of an integrated side seat ring (4), a hydraulic oil cylinder (1) is disposed above each of the oil cylinder installation holes (5), the position of each of the oil cylinder installation holes (5) corresponds to the position of bead heel of the tire (7), the integrated side seat ring (4) is disposed on a face of the rim (8) that is in contact with the tire, the hydraulic oil cylinder (1) is provided with an oil cylinder ejecting rod (2), one end of the oil cylinder ejecting rod (2) that is inserted into one of the oil cylinder installation holes (5) is connected to a T-type cylindrical pushing plate (3), and the T-type cylindrical pushing plate (3) is located closely to the bead heel of the tire (7), and each of the oil cylinder installation holes (5) is provided with a dust preventing cover (9). This device has the advantages such as strong demounting power, safe demounting operation, long service life of the rim, and reduced demounting and repair costs.

### TECHNICAL FIELD

The current invention is related to a device for demounting a tire of a load-carrying vehicle, and especially related to a device for hydraulically demounting a tire of a heavy duty vehicle.

### TECHNICAL BACKGROUND

With the increase of the production scale of various open pit mines in the world, the loading capacity of a super large-scale mining truck is becoming increasingly higher, with some mining trucks having a capacity of more than 400 tons. Even so, the loading capacity tends to be further increased. The increase of the loading capacity demands higher standards of vehicles, wheels and rims. For example, due to the heavy load of the super large-scale trucks used in various mines around the world as well as the bad condition of the road surface, the truck wheels have very short service life. In some cases, the new wheels are broken only after 2-3 months of use and need to be replaced. Frequent replacement of wheels is a major task in the maintenance of super large-scale vehicles.

The rim is installed on the periphery of a wheel and serves to support the tire. The rim of a heavy load-carrying vehicle in the state of the art features a structure in which the side ring and the beat seat are separated, the side ring forms a 5 element or 7 element rim structure with the cylinder body, the locking ring and some other parts. The locking ring, the side ring and the beat seat are manually separated in order to dissemble and repair the wheel and the rim. Due to the large diameter of the wheels of the heavy load-carrying truck, the tire is heavy and also large in diameter, making the demounting of the tire difficult. There have been many accidents during the demounting process. Moreover, the wheel rim may be damaged during the demounting process, which leads to shortening of its service life and therefore an increase of costs in use of the load-carrying vehicles.

The present applicant has been doing researches on the tire demounting technique over the years and has filed a number of patent applications. The most recent patent application is related to a technique, wherein the rim is provided with a bolt hole, and the bearing plate is pushed by twisting the bolt in order to demount the tire. However, this technique still requires manual operation, and still cannot overcome the defects such as long demounting time, high labor intensity and too many accidents during the demounting process.

### SUMMARY OF THE INVENTION

Therefore, the goal of the current invention is to provide a device for demounting a tire in a heavy duty vehicle. Such a device enables an easy and quick demounting process, low labor intensity during the demounting process, and guaranteed personal safety during the demounting process. In addition, the device for hydraulically demounting a tire of a heavy duty vehicle does not damage the rim.

The goal of the invention is achieved by a device for hydraulically demounting a tire of a heavy duty vehicle consisting of a tire and a rim, characterized in that a plurality of oil cylinder installation holes are evenly distributed on the periphery of an end face of an integrated side seat ring, wherein
a hydraulic oil cylinder is disposed above each oil cylinder installation hole,
the positions of the oil cylinder installation holes correspond to the position of the bead heel of the tire,
the integrated side seat ring is disposed on a face of the rim that is in contact with the tire,
the hydraulic oil cylinder is provided with an oil cylinder ejecting rod, wherein one end of the oil cylinder ejecting rod is inserted into the oil cylinder installation hole, and this end is connected to a T-type cylindrical pushing plate, and the T-type cylindrical pushing plate is located against the bead heel of the tire, and
each oil cylinder installation hole is provided with a dust preventing cover.

The best set-ups are 3 to 8 oil cylinder installation holes that are evenly distributed on the periphery of the rim and 3 to 8 corresponding hydraulic oil cylinders.

The integrated side seat ring is composed of two faces which are perpendicular to each other, wherein the two faces are connected with the side face of the bead heel of the tire and its neighboring face, respectively.

The point of the current invention is the even distribution of a plurality of hydraulic oil cylinder tire demounting devices on the periphery of the rim. When the hydraulic oil cylinders are working, the oil cylinder ejecting rod pushes the T-type cylindrical pushing plate. The T-type cylindrical pushing plate then pushes the bead heel of the tire, so that the tire separates from the integral side seat ring to demount the tire.

A rim is a part installed on the periphery of a wheel to support the tire. Vehicles with large loading capacity have large tires with large rims. According to the current invention, 3 or more hydraulic oil cylinder tire demounting devices are evenly distributed on the periphery of the rim, depending on the size of the rim. The position of the oil cylinder installation hole corresponds to the position of bead heel of the tire. The oil cylinder ejecting rod and the pushing rod of the hydraulic oil cylinder tire demounting device are placed in the oil cylinder installation hole, in order to accurately push the bead heel of the tire to demount the tire.

The number of the oil cylinder installation holes and that of the corresponding oil cylinders are determined by the diameter of the rim. The most preferred number is 3 to 8.

The face of the T-type cylindrical pushing plate which is in contact with the bead heel of the tire is circular, oval, rectangular, polygonal or irregularly polygonal. The area of the pushing plate is larger than that of the cross-section of the ejecting rod.

The integrated side seat ring is composed of two faces which are perpendicular to each other, wherein the two faces are connected with the side face of the bead heel of the tire and its neighboring face, respectively.

In order for the oil cylinder ejecting rod to be tightly connected with the T-type cylindrical pushing plate, the top of the oil cylinder ejecting rod is provided with a fixed pin, wherein the length of the fixed pin is shorter than the depth of the oil cylinder installation hole.

The bead heel of the tire is provided with a hexagonal-ring shaped steel ring with its inscribed circle having a diameter of 48 mm, wherein the periphery of hexagonal-ring shaped steel ring is provided with a circular net.

The dust preventing cover is connected with the rim bolt.

The current invention has no restriction on the size and shape of the oil cylinder installation holes in the integrated side seat ring, as long as the size and shape of the oil cylinder installation holes match those of the oil cylinder ejecting rod and the T-type cylindrical pushing plate to enable the demounting of the tire.

The size of the T-type cylindrical pushing plate fits the size of the tire rim as well as the size of the integrated side seat ring.

The T-type cylindrical pushing plate is 8 mm shorter than the oil cylinder installation hole to leave some space for the insertion and positioning of the oil cylinder ejecting rod so as to ensure an accurate operation of the oil cylinder ejecting rod with the pushing rod.

The pushing rod of the present invention serves to transmit the hydraulic pushing force of the oil cylinder. In order to increase the pushing area and achieve the demounting task, one end of the pushing rod, which is close to the bead heel of the tire, is provided with a pushing plate. The current invention has no restriction on the shape and the size of the T-type cylindrical pushing plate. For instance, the pushing plate can be rectangular, circular, oval, hexagonal or polygonal, which all fall within the protection scope of the current invention.

In the current invention, a side ring is provided between the inner wall of the rim and the tire, wherein the side ring serves to protect the tire tube. In the state of the art, a side ring consists of a side ring part and a beat seat part. The current invention differs from the state of the art in that the current invention and features an integrated side seat ring, namely the side ring and the beat seat form an integral part. Such a design features a simple structure. The integral side seat ring is not easy to break and has a long lifespan. In the meantime, the safety of the rim is assured. The demounting of the tire is facilitated.

The multiple demounting devices for each rim are interchangeable. The oil cylinder installation holes, the hydraulic oil cylinders and the oil cylinder ejecting rods are all with the same standards and sizes, respectively. The demounting devices used in the same rim are interchangeable, so the installation process and the operation are facilitated.

The above described devices are only installed and used during the demounting process. When the heavy duty vehicle is working normally, the hydraulic oil cylinders will not be installed above the oil cylinder installation holes and the oil cylinder ejecting rods will not be positioned in the oil cylinder installation holes. The oil cylinder installation holes are covered with dust preventing covers, in order to prevent the dust in the environment from entering into the equipment and thus to keep the rim, side ring and other equipment safe. The dust preventing covers are flat thin plates. They cover the oil cylinder installation holes and are fixed onto the rims via bolts according to state of the art. The middle of each dust preventing cover is provided with a central hole. The bolt goes through the central hole to fix the T-type cylindrical pushing plate provided in the oil cylinder installation hole. The dust preventing hole has two functions. The first one is for protection, i.e., to prevent the dust in the environment from entering into the equipment, in order to enhance the safety of the wheel. The second one is for fixing, i.e., to connect the central hole of the dust preventing cover to the T-type cylindrical pushing plate so as to fix the T-type cylindrical pushing plate. When the tire is to be demounted according to the current invention, the hydraulic oil cylinder is fixed onto the rim via the bolt according to state of the art.

The current invention applies specialized bolt to fix the hydraulic oil cylinder. The oil cylinder ejecting rod and the T-type cylindrical pushing plate cooperate with each other, so that the demounting device of the current invention performs the demounting very fast with high efficiency and high degree of safety.

The current invention has no restriction on the type of the hydraulic oil cylinders. Regardless of its type, once the piston of the hydraulic oil cylinder connects with the oil cylinder ejecting rod and the T-type cylindrical pushing plate to separate the tire from the blocking beat seat, the demounting task can be well achieved.

The current invention has no restriction on the type of the heavy duty vehicles. The current invention can be used to demount the tire in a heavy duty truck, an excavator, a bulldozer or other types of heavy duty vehicles.

The current invention has no restriction on the number of the tires. The current invention can be used to demount the tire in vehicles with four wheels, six wheels, eight wheels or more wheels. The current invention also has no restriction on the diameter of the tire. The current invention can be used to demount tires regardless of the diameter of the tire. The current invention has no restriction on the position of the tire, and the current invention can be used to demount the tires no matter the tires are located at the front or at the back or at any other places of the vehicle.

The current invention has no restriction on the regions where the heavy duty vehicles are being used. The current invention can be used all over the world to demount the tires of heavy duty vehicles.

The current invention has no restriction on the tasks for the heavy duty vehicles. No matter the vehicles are used in mining, tunnel construction, river channel excavation, architectural engineering, or railway construction, the current invention can be applied.

The technical nature of the current invention is to utilize the hydraulic force produced by the hydraulic oil cylinder, to push the bead heel of the tire with the oil cylinder installation holes in the integrated side seat ring, the oil cylinder ejecting rod and the T-type cylindrical pushing plate, so as to separate the tire from the side ring and the rim. In comparison with the device for demounting a tire of a heavy duty vehicle in state of the art, the current invention has made substantial technical improvements.

After wide review of the publications as well as patent documents in China and abroad, no technical solution has been found to be identical to the current invention. Therefore, the current invention features novelty and inventive step. The hydraulic device for demounting a tire of a heavy duty vehicle according to the current invention can be used all over the world on all kinds of heavy duty vehicles and thus has wide application.

Over a long period of time, due to the large diameter and the heavy weight of the tire of the heavy duty vehicles, the demounting has been difficult and the demounting time has been long. In addition, the labor intensity as well as the number of accidents is high during the demounting process. The rim is easy to be damaged during the demounting process which results in a shortened lifetime of the rim and thus increases the use costs of the heavy duty vehicles. The current invention is an invention which solves a long-existing but difficult-to-be-solved problem of demounting a tire of a heaving duty vehicle.

The characteristics of the current invention are as follows.

1. Each tire is provided with multiple groups of hydraulic oil cylinder tire demounting devices and multiple hydraulic oil cylinders. The demounting force is strong. This fundamentally solves the technical problem of demounting tires in a heavy duty vehicle.

2. No labor force is required, and the human safety during the demounting process is ensured.

3. The dust preventing cover prevents dust from entering the rim, which enhances the safety of the wheel.

4. The demounting is done with a high speed and efficiency as well as high safety.

5. The side ring and the beat seat are integrated, which improves the strength of the side ring, protects the rim, and prolongs the lifespan of the rim and the side ring.

The advantages of the present invention are obvious.

1. The demounting force is strong. As a result, no matter how heavy the load of the heavy duty vehicle is, and regardless of the condition under which the heavy duty vehicle works, the tire can all be successfully demounted. The present invention has a profound impact and wide application on the development of future super heavy duty vehicles.

2. Each tire is provided with multiple hydraulic oil cylinders working simultaneously, and therefore, the tires can be successfully demounted regardless of the diameters of the wheel and the rim in the heavy duty vehicles. The present invention has a profound impact and wide application on the development of future super heavy duty vehicles.

3. Since manpower is replaced with hydraulic force, the safety of the operating personnel is ensured.

4. Since the components in each group of hydraulic oil cylinder demounting device are made with general standards, it is easy to assemble and disassemble the device. Also, the devices can be interchangeably used, and can be used repeatedly which reduces demounting costs.

5. The dust preventing cover prevents dust from entering the device, which improves the safety of the wheel.

6. Since the side ring is an integral side ring, the side ring and the rim will have a long lifespan, which reduces the repair costs.

### BRIEF DESCRIPTION OF THE DRAWINGS

FIG. 1 shows the structure of the device for hydraulically demounting a tire of a heavy duty vehicle according to the current invention.

FIG. 2 shows the position of the dust preventing cover as well as its installation.

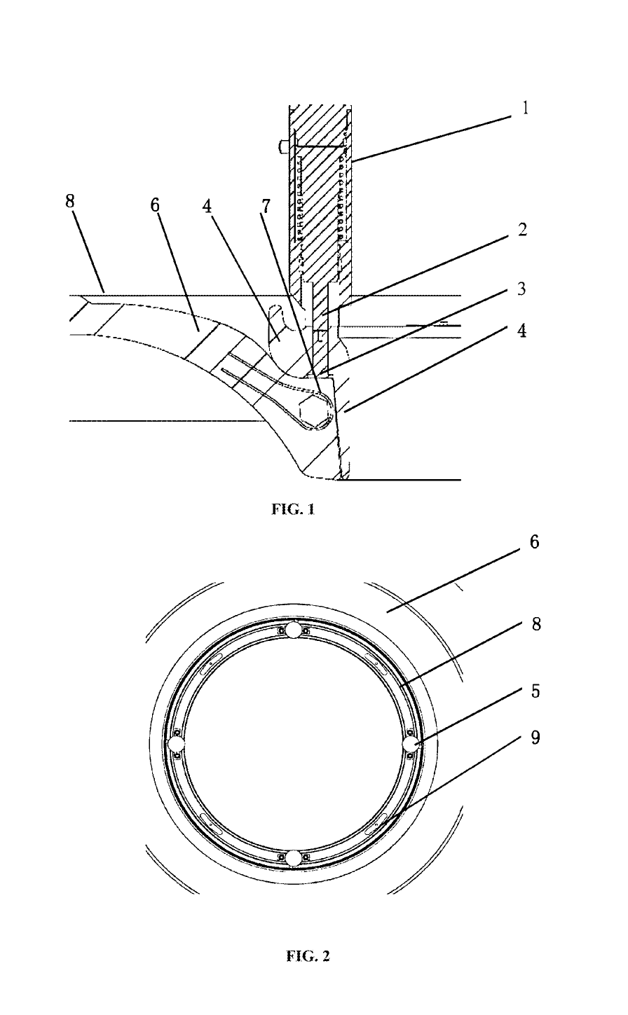

In the figures:
1. hydraulic oil cylinder;
2. oil cylinder ejecting rod;
3. T-type cylindrical pushing plate;
4. Integrated side seat ring;
5. Oil cylinder installation hole;
6. Tire;
7. Bead heel of the tire;
8. Rim;
9. Dust preventing cover.

### DETAILED DESCRIPTION OF THE DRAWINGS

The current invention is further illustrated by the following embodiment.

### Example 1

A heavy duty vehicle with the maximum loading of 320 tons had 6 wheels. The diameter of each rim was 63″. The integral blocking-beat seat 4 was provided with eight oil cylinder installation holes 5 which were evenly distributed. The oil cylinder installation holes 5 corresponded to the bead heel 7 of the tire 6. Each oil cylinder installation hole 5 worked with one group of the hydraulic demounting device with the hydraulic oil cylinder 1 located above the oil cylinder installation hole 5. The piston of the hydraulic oil cylinder 1 was connected with an oil cylinder ejecting rod 2. One end of the oil cylinder ejecting rod 2 was connected with the T-type cylindrical pushing plate 3. During tire demounting, the hydraulic oil cylinder 1 worked, and the hydraulic oil cylinder piston rod pushed the oil cylinder ejecting rod 2 and the T-type cylindrical pushing plate 3. The T-type cylindrical pushing plate 3 pushed the bead heel of the tire 7 which counter-reacted on the integral side seat ring 4. The integral blocking-beat seat 4 was separated from the bead heel of the tire 7, so that the tire 6 was separated from the integral blocking-beat seat 4 and the tire was demounted. After the tire 6 was demounted, the hydraulic oil cylinder 1 was disassembled, and the T-type cylindrical pushing plate 3 moved back to the hole. The oil cylinder installation hole 5 was covered with a dust preventing cover 9, wherein the dust preventing cover was fixed to the rim 8 via a bolt.

The foregoing example is only one preferable example of the current invention, and the current invention is not limited thereto. Any substitution, revision or change made within the spirit of the current invention and regarded as equivalent will fall within the scope of the current invention.

What is claimed is:

1. A device for hydraulically demounting a tire of a heavy duty vehicle consisting of a tire (6) and a rim (8), characterized in that a plurality of oil cylinder installation holes (5) are evenly distributed on the periphery of an end face of an integrated side seat ring (4), wherein
a hydraulic oil cylinder (1) is disposed above each of the plurality of the oil cylinder installation holes (5),
the position of each of the plurality of the oil cylinder installation holes (5) corresponds to the position of bead heel of the tire (7),
the integrated side seat ring (4) is disposed on a face of the rim (8) that is in contact with the tire,
the hydraulic oil cylinder (1) is provided with an oil cylinder ejecting rod (2), wherein one end of the oil cylinder ejecting rod (2) is inserted into one of the plurality of the oil cylinder installation holes (5), and this end is connected to a T-type cylindrical pushing plate (3), and the T-type cylindrical pushing plate (3) is located closely to the bead heel of the tire (7), and
each of the plurality of the oil cylinder installation holes (5) is provided with a dust preventing cover (9).

2. The device for hydraulically demounting a tire of a heavy duty vehicle according to claim 1, characterized in that the best set-ups are 3-8 groups of the oil cylinder installation holes (5) that are evenly distributed on the periphery of the rim (8) and the corresponding hydraulic oil cylinders (1).

3. The device for hydraulically demounting a tire of a heavy duty vehicle according to claim 1, characterized in that the integrated side seat ring (4) is composed of two faces which are perpendicular to each other, wherein the two faces are connected with the side face of the bead heel of the tire (7) and its neighboring face, respectively.
